(19) United States
(12) Patent Application Publication
(10) Pub. No.: US 2026/0132253 A1
(43) Pub. Date: May 14, 2026

(54) Shell-and-Tube Reactor for Synthesizing Polycarbonate Polyether Polyols

(71) Applicant: Hefei Puli Advanced Materials Technology Co., Ltd., Hefei (CN)

(72) Inventors: Xiaojie XING, Hefei (CN); Hongbing MAO, Hefei (CN); Zhichun YU, Hefei (CN); Zhigen ZOU, Hefei (CN)

(21) Appl. No.: 19/387,858

(22) Filed: Nov. 13, 2025

(30) Foreign Application Priority Data
Nov. 13, 2024 (CN) 202411615495.9

(51) Int. Cl. C08G 65/26; B01J 8/00; B01J 8/06

(52) U.S. Cl. CPC C08G 65/2696; B01J 8/001; B01J 8/067; C08G 65/2603; C08G 65/2663; B01J 2208/00044; B01J 2208/00539; B01J 2208/00548; B01J 2208/065

(57) ABSTRACT

A shell-and-tube reactor for synthesizing polycarbonate polyether polyols is equipped with dedicated solid-liquid mixing units, carbon dioxide-epoxide heat transfer units, circulation control units, temperature control units, and pressure control units, thereby achieving high structural compatibility and integrated coordination between the reactor's internal configuration, material circulation, and reaction heat management. This design provides sufficient mixing, efficient mass and heat transfer, and precise temperature control for the synthesis process. The invention enables a one-step, single-feed synthesis of polycarbonate polyether polyols and facilitates large-scale industrial production with enhanced efficiency and product quality.

### CROSS REFERENCE OF RELATED APPLICATIONS

This application claims foreign priority of Chinese Patent Application No. 202411615495.9, filed on 13 Nov. 2024 in the China National Intellectual Property Administration (CNIPA), the entire contents of which are hereby incorporated by reference in their entireties.

### TECHNICAL FIELD

The present invention relates to the technical field of polycarbonate polyether polyol preparation, and more particularly, to a shell-and-tube reactor used for synthesizing polycarbonate polyether polyols.

### BACKGROUND

Polycarbonate polyether polyols are a class of polyols containing carbonate groups within their molecular chains and hydroxyl groups at the chain ends. One of the raw materials, carbon dioxide, is inexpensive, readily available, non-toxic, and non-flammable, and provides effective chemical fixation of carbon dioxide. The reaction proceeds under relatively mild temperature and low energy consumption. The copolymerization of carbon dioxide with epoxides exhibits broad application prospects and high industrial value.

The synthesis of polycarbonate polyether polyols is primarily achieved by reacting a chain transfer agent, carbon dioxide, and an epoxide in the presence of a zinc-cobalt double-metal cyanide (DMC) catalyst. Taking propylene oxide and succinic acid as examples of the epoxide and chain transfer agent, respectively, the synthesis route is as follows:

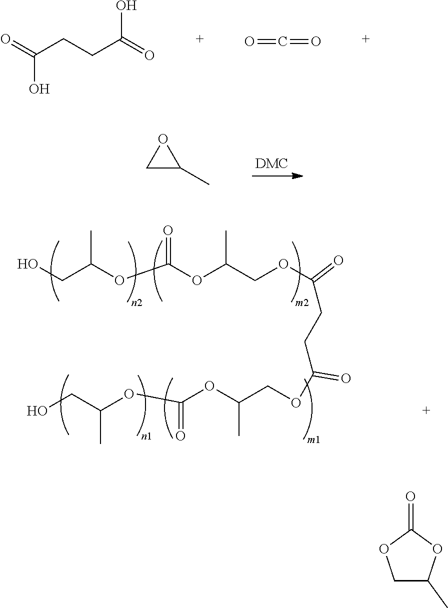

where m₁ and m₂ represent the average number of ether chain segments, and n₁ and n₂ represent the average number of ester chain segments. Chinese Patent CN111378106A discloses that the activation energy for polymer formation is lower than that for cyclic carbonate formation, while the potential energy of cyclic carbonate is lower than that of the polymer. Consequently, the formation of cyclic carbonate is thermodynamically favorable, whereas the formation of polycarbonate is kinetically favorable. Excessively high reaction temperatures reduce carbonate segment content, broaden molecular weight distribution, and increase cyclic carbonate by-products. Therefore, precise control of reaction temperature is critical for improving the yield of the main product-polycarbonate polyether polyol.

Another key factor affecting product yield is the performance of the double-metal cyanide (DMC) catalyst. Improper or instantaneous activation of the DMC catalyst can lead to runaway polymerization, posing high-temperature and high-pressure safety risks. Chinese Patent CN115785435A summarizes the DMC catalytic mechanism as comprising an induction activation period and a chain growth period. During the induction activation period, the reaction is exothermic, and temperature peaks must be monitored to prevent overheating, which can impair both the pressure resistance of the equipment and the catalytic activity. During the chain growth period, the fully activated DMC catalyst forms active centers that react with the chain transfer agent, enabling epoxide insertion and polymer chain propagation. This phase requires external heating to promote chain growth. Chinese Patent CN106471042B defines the activation process of the DMC catalyst during the induction period as follows: a partial amount of epoxide is added to the DMC catalyst, optionally in the presence of CO₂, and then the feed of epoxide is stopped. A subsequent exothermic reaction produces an observable temperature peak (“hot spot”) and/or a pressure drop within the reactor. The activation period is defined as the time interval from the partial addition of the epoxide to the catalyst until the hot spot subsides.

To accommodate the characteristics of the polycarbonate polyether polyol synthesis reaction and to minimize the impact of thermal fluctuations on the reaction components, the prior art generally employs specialized catalyst design, process control strategies, and/or independent reactor configurations during the induction activation phase. Examples include: (1) Catalyst Design: As disclosed in Chinese Patent CN115785435B, a highly active and thermally stable tridentate double-metal cyanide (DMC) catalyst is employed, allowing for a one-step feed of the catalyst, chain transfer agent, and epoxide at room temperature to synthesize polyether polyols. (2) Process Optimization: Chinese Patent CN116710504A introduces a catalyst pre-activation technique, wherein the catalyst is pretreated with an initiator compound or with a reaction product from prior reactions, allowing partial activation before the remaining raw materials are fed either batchwise or continuously. Similarly, CN107108878A discloses a method for preparing polyether carbonate polyols, wherein the DMC catalyst is pretreated under 50-200° C. and/or 10-800 mbar absolute pressure, and the catalyst, epoxide, suspending agent, and/or hydroxyl-functional initiator are metered intermittently or continuously into a first reactor. (3) Reactor Configuration: Chinese Patent CN116874759A proposes using separate reactors for catalyst activation and activity maintenance to address issues of incomplete or instantaneous DMC activation, which may cause runaway polymerization and safety hazards. This system includes a first reactor for catalyst activation, a tubular reactor, and a second reactor. The first reactor is charged with the chain transfer agent and DMC catalyst, heated to 120-140° C., and fed with epoxide for catalyst activation; subsequently, the temperature is reduced to 70-90° C. while maintaining activity. CN103403060B describes connecting two tubular reactors of different diameters in series to control the DMC activation phase. CN106471042B discloses a configuration in which a stirred-tank main reactor and a tubular reactor are connected in series, maintaining the tubular reactor temperature 10-40° C. higher than that of the main reactor, such that the DMC activation occurs in the main reactor and chain propagation occurs in the tubular reactor.

However, from a reactor design standpoint, no existing technology has disclosed a reactor structure capable of achieving one-step feed synthesis of polycarbonate polyether polyols.

Currently, industrial production of polycarbonate polyether polyols typically employs either stirred-tank reactors or tubular reactors. Stirred-tank reactors have a low surface area-to-volume ratio, resulting in poor heat dissipation and difficulties handling highly exothermic reactions. Tubular reactors, in contrast, allow for precise control of temperature and pressure, providing high monomer conversion efficiency and thus gaining wide attention in this field. However, the small cross-sectional area of tubular reactors limits their throughput, necessitating the use of multiple tubes arranged in parallel to form shell-and-tube reactors. Conventional shell-and-tube reactors equipped with external high-efficiency mixers, such as that disclosed in CN109225114A, consist of multiple tubes within a shell and rely on external circulation for material mixing. However, during the synthesis of polycarbonate polyether polyols, stricter requirements exist for material dispersion and heat removal. The reactor must rapidly dissipate reaction heat and prevent runaway polymerization. Moreover, solid catalyst tends to accumulate near tube heads, hindering the progress of the synthesis reaction. Therefore, conventional shell-and-tube reactors are unsuitable for industrial production of polycarbonate polyether polyols.

To increase residence time and improve conversion, reactors specifically designed for polycarbonate polyether polyol synthesis typically employ long tubular structures with a large length-to-diameter ratio (L/d>50), as described in CN103403060B. However, such configurations inherently suffer from mixing and heat-transfer limitations. As the carbonate content increases, the viscosity of the product rises exponentially. The elongated, narrow tube confines the material within slender tube segments, impeding homogeneous mixing throughout the reactor. As viscosity increases sharply during polymerization, flowability decreases, leading to localized hot spots and potential runaway polymerization. This chain-type runaway reaction prevents the synthesis of the desired product.

Another issue in industrial-scale production is the scaling-up effect. As defined in CN111484610A, the scaling-up effect refers to discrepancies between results obtained at small-scale (e.g., laboratory) and large-scale (e.g., industrial) processes under identical operating conditions. In polycarbonate polyether polyol synthesis, increasing material viscosity impedes heat dissipation, causing temperature rise, which accelerates reaction rate and heat generation. This feedback loop intensifies with larger material volumes, making the scaling-up effect inevitable.

Therefore, in the technical field of polycarbonate polyether polyol preparation, there is currently no shell-and-tube reactor capable of achieving one-step feed synthesis while ensuring efficient gas-liquid mass transfer, uniform solid-liquid-gas mixing, sufficient heating and cooling, and elimination of scaling-up effects.

### SUMMARY

In view of the deficiencies of the prior art, the present invention discloses a shell-and-tube reactor specifically designed for synthesizing polycarbonate polyether polyols. The reactor employs reaction tubes with a small length-to-diameter ratio and is equipped with a specially configured carbon dioxide-epoxide heat transfer unit, solid-liquid mixing unit, circulation control unit, temperature control unit, and pressure control unit. Through the coordinated integration of the reactor's internal structure with material circulation and reaction heat management, the invention achieves highly efficient heat transfer and uniform mixing. The reactor is particularly suitable for large-scale industrial production of polycarbonate polyether polyols.

The technical solution of the present invention is as follows: a shell-and-tube reactor for synthesizing polycarbonate polyether polyols, comprising a reaction tube, and further including:
A carbon dioxide-epoxide heat transfer unit disposed at the upper portion of the reaction tube, configured to reduce the temperature of the reaction materials;
A solid-liquid mixing unit disposed within the reaction tube and positioned below the carbon dioxide-epoxide heat transfer unit;
A circulation control unit configured to drive the circulating flow of materials within the reaction tube;
A temperature control unit configured to regulate the temperature within the reaction tube; and

A pressure control unit configured to regulate the internal pressure within the reaction tube.

The circulation control unit, temperature control unit, and pressure control unit operate cooperatively to regulate the entire reaction process. The specific process is as follows:

After the one-step feeding of the epoxide, chain transfer agent, and catalyst into the reaction tube, only carbon dioxide is subsequently supplied during the reaction. The circulation control unit transfers the materials from the solid-liquid mixing unit to the carbon dioxide-epoxide heat transfer unit. After the material temperature is reduced, the materials are returned to the solid-liquid mixing unit. The circulation control unit adjusts the circulation rate of the materials, while the temperature control unit and pressure control unit maintain the temperature in the upper portion of the reaction tube lower than that in the lower portion. The temperature difference between the middle and lower sections of the reaction tube does not exceed 5° C., and the material temperature within the reaction tube increases progressively along the flow direction, forming a temperature gradient.

The reaction tube has a length-to-diameter ratio (L:d) of less than 50.

The material within the reactor is a mixture of reaction raw materials and reaction products, including but not limited to the epoxide, chain transfer agent, catalyst, and the resulting polycarbonate polyether polyol.

The reaction takes place within the reaction tube. During the reaction, the epoxide and chain transfer agent are continuously consumed and react under the catalysis of the DMC catalyst to form polycarbonate polyether polyols, resulting in an overall increase in the viscosity and density of the reaction materials.

The carbon dioxide-epoxide heat transfer unit comprises a gas-liquid mass transfer and heat exchange zone. In this zone, the epoxide absorbs carbon dioxide, while the carbon dioxide simultaneously absorbs heat from the liquid phase, thereby achieving gas-liquid mass and heat transfer to reduce the temperature of the reaction materials.

The term “one-step feeding” refers to the process in which the epoxide, chain transfer agent, and catalyst are introduced into the shell-and-tube reactor at one time for the reaction, and during the reaction process, only carbon dioxide is supplemented, with no further addition of these three raw materials.

The shell-and-tube reactor of the present invention provides sufficient mixing, mass transfer, heat transfer, and precise temperature control for the synthesis of polycarbonate polyether polyols. It eliminates the need for catalysts with special structural designs or pre-activation treatments. Both the catalyst induction activation phase and the chain-growth phase can occur within the same reaction tube, thereby enabling a one-step feeding process for synthesizing polycarbonate polyether polyols. This process produces high-quality polycarbonate polyether polyols without scaling-up effects, making it suitable for large-scale industrial production. The technical solution employs a reaction tube with a small length-to-diameter ratio (L:d<50) and integrates specifically configured carbon dioxide-epoxide heat transfer, solid-liquid mixing, circulation control, temperature control, and pressure control units. These units operate synergistically with the reaction tube to ensure effective material mixing and mass/heat transfer, achieve precise temperature control at specific locations within the tube, enable efficient heat dissipation, and prevent runaway polymerization.

In one embodiment, the temperature control unit comprises temperature sensors positioned to detect the temperatures of materials in the upper, middle, and lower regions of the reaction tube, a jacket for heating or cooling the reaction tube, and a heat-transfer medium filled between the jacket and the reaction tube.

In one embodiment, when the temperature in the middle region of the reaction tube exceeds a predetermined reaction temperature threshold, the temperature control unit is adjusted to lower the internal temperature of the reaction tube while increasing the circulation rate of the materials and the carbon dioxide feed rate until the middle-section temperature is maintained within the desired threshold range. When the temperature difference between the middle and lower regions exceeds a preset temperature-difference threshold, the material circulation rate and carbon dioxide feed rate are increased until the temperature difference does not exceed the specified limit.

In one embodiment, a density sensor is disposed at the outlet of the reaction tube to measure the material density, and the reaction progress is controlled based on the rate of change in material density.

In one embodiment, the process of controlling the overall reaction further comprises that, when the rate of change in material density per minute exceeds a predetermined density change rate threshold, the circulation speed of the material and the carbon dioxide feed rate are increased until the density change rate no longer exceeds the threshold.

In one embodiment, the carbon dioxide-epoxide heat transfer unit is located within a gas-liquid mass transfer and heat exchange zone. The gas-liquid mass transfer and heat exchange zone occupies the upper space of the reaction tube and has a volume greater than or equal to 20% of the total volume of the reaction tube.

In one embodiment, the carbon dioxide-epoxide heat transfer unit includes a gas distributor positioned 10-50 mm below the top of the reaction tube. The gas distributor has a porous structure. Preferably, the pores are elliptical with a major axis of 2 mm and a minor axis of 1 mm; preferably, the porous structure is arranged in a rectangular pattern; and preferably, the pore spacing is 3 mm.

In one embodiment, the solid-liquid mixing unit includes a mixer. Preferably, the mixer is a static mixer.

In one embodiment, the inner diameter of the reaction tube ranges from 100 mm to 1500 mm.

In one embodiment, the reaction tube has a length-to-diameter ratio satisfying 10≤L:d≤40.

In one embodiment, the number of reaction tubes is between two and eight.

In one embodiment, the reaction tubes are connected in parallel, and the center-to-center distance between adjacent tubes is less than or equal to twice the tube diameter.

In one embodiment, the reaction tubes are independent of one another and can be isolated by valves.

In one embodiment, each reaction tube and the circulation unit share an identical material circulation path.

In one embodiment, the circulation speed of the circulation unit is 10-20 minutes per cycle.

Compared with the prior art, the shell-and-tube reactor provided by the present invention adopts reaction tubes with a small length-to-diameter ratio and is equipped with specifically designed carbon dioxide-epoxide heat transfer, solid-liquid mixing, circulation control, temperature control, and pressure control units. These units operate synergistically with the reaction tube structure to provide sufficient mixing, efficient mass and heat transfer, and precise temperature control for the synthesis of polycarbonate polyether polyols. The reactor offers the following advantageous effects:
(1) The reaction process is controlled collaboratively based on temperature, pressure, and material density within the reaction tube. Through the circulation of materials, the reactor achieves efficient mixing, effective mass and heat transfer, and precise temperature regulation, enabling the synthesis of high-quality polycarbonate polyether polyols.
(2) The process uses only conventional catalysts without the need for pre-activation. Both the catalyst induction activation phase and the chain-growth phase can occur within the same reaction tube, thereby realizing a one-step feeding process for synthesizing polycarbonate polyether polyols.
(3) The process eliminates scaling-up effects, making it suitable for large-scale industrial production of polycarbonate polyether polyols.

### BRIEF DESCRIPTION OF THE DRAWINGS

To further illustrate the technical solutions of the embodiments of the present invention or those of the prior art, the drawings used in the embodiments are briefly described below. It should be apparent that the drawings described below are merely some embodiments of the present invention. For those skilled in the art, other drawings can be derived from these figures without inventive effort.

FIG. 1 is a side schematic view of the shell-and-tube reactor according to an embodiment of the present invention.

FIG. 2 is a top schematic view of the shell-and-tube reactor according to an embodiment of the present invention.

FIG. 3 is a comparative graph showing the density change curves of the polycarbonate polyether polyols obtained in Example 1 and Comparative Examples 1-7.

Reference Numerals: 1-Gas replenishment port; 2-First temperature sensor; 3-Second temperature sensor; 4-Third temperature sensor; 5-Liquid distributor; 6-Gas distributor; 7-Jacket; 8-Mixer; 9-Reaction tube; 10-Density sensor; 11-Circulation device; 12-Connecting pipeline; 13-Heat transfer medium

### DETAILED DESCRIPTION OF THE EMBODIMENTS

To make the objectives, technical solutions, and advantages of the present invention more apparent, the embodiments of the invention are described in further detail below with reference to the accompanying drawings. It should be understood that the embodiments described herein represent only a portion of the embodiments of the invention and are not intended to limit the invention. The invention should not be construed as limited to the exemplary embodiments described herein. In the description of the present invention, it should be noted that the terms “upper,” “lower,” “left,” “right,” “vertical,” “parallel,” “inner,” “outer,” “front,” “rear,” and the like denote orientations or positional relationships based on those illustrated in the drawings, and are used merely for ease of description and simplification. They do not imply that the devices or components referred to must have a particular orientation, structure, or method of operation and should not be interpreted as limiting the scope of the invention.

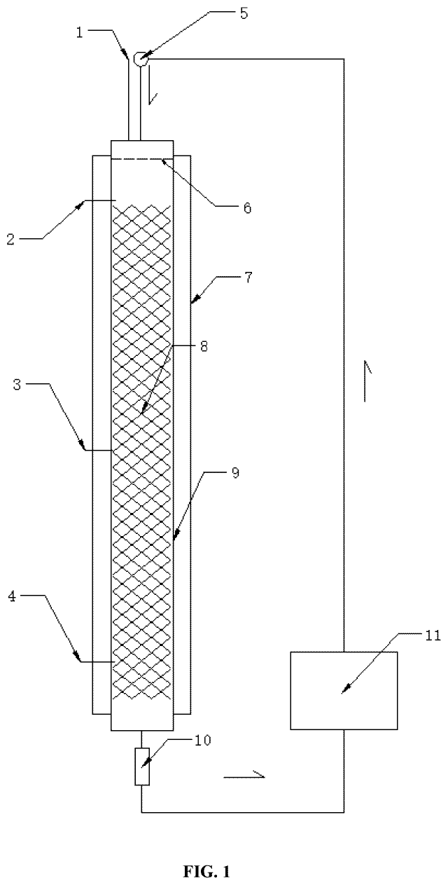

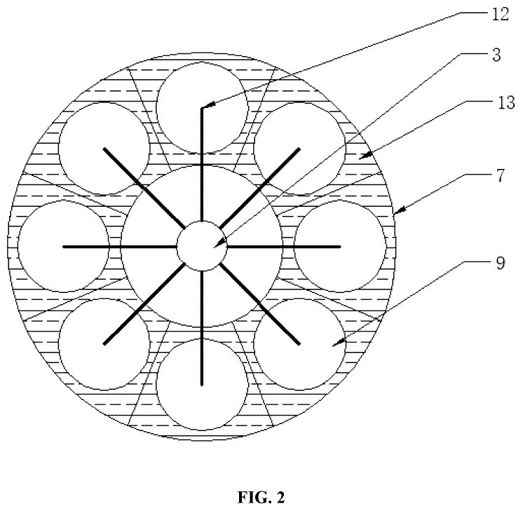

FIG. 1 illustrates a side view, and FIG. 2 illustrates a top view of the shell-and-tube reactor according to an embodiment of the present invention. As shown in FIGS. 1 and 2, the shell-and-tube reactor of the present invention comprises: a reaction tube 9; a carbon dioxide-epoxide heat transfer unit, which includes a gas distributor 6 disposed at the upper portion of the reaction tube; a solid-liquid mixing unit, which includes a mixer 8 positioned within the reaction tube and located below the gas distributor 6; a temperature control unit, which includes a first temperature sensor 2 positioned in the upper portion of the reaction tube, a second temperature sensor 3 positioned in the middle portion, and a third temperature sensor 4 positioned in the lower portion; a jacket 7 surrounding the outer wall of the reaction tube; and a heat-transfer medium 13 filled between the reaction tube and the jacket; a circulation control unit, which includes a density sensor 11 located at the outlet at the lower end of the reaction tube and a circulation device 11; a pressure control unit, which includes a gas replenishment port 1 positioned at the inlet on the upper end of the reaction tube; and multiple reaction tubes connected in parallel, wherein the reaction feedstock is distributed to each reaction tube through a liquid distributor 5 and connecting pipelines 12.

To ensure thorough mixing of raw materials and to prevent uneven reactions that may lead to excessive molecular weight distribution or runaway polymerization, a reaction preparation stage is required prior to introducing the solid-liquid reactants into the shell-and-tube reactor. Under a carbon dioxide atmosphere at 0.1-0.5 MPa, the epoxide feedstock is purified and transferred from a storage tank into a raw material mixing device, followed by the addition of the chain transfer agent and catalyst for thorough mixing with the epoxide. The premixing temperature ranges from 0° C. to 60° C., the pressure from 0.1 MPa to 2 MPa, and the premixing duration is 1˜4 hours. The raw material mixing device may include, but is not limited to, a premixing kettle or a Venturi mixer. At this stage, only physical mixing occurs in the raw material mixing device to ensure full dissolution and uniform distribution of reactants, without initiating polymerization or catalyst activation.

After premixing, the raw materials are introduced via a metering pump through the feed inlet into the reaction tube maintained at a temperature of 40° C. and a CO₂ pressure of 0.1-2 MPa. When a predetermined amount of material has entered the reaction tube, feeding is stopped. Carbon dioxide is then introduced through the gas replenishment port 1, and the circulation device 11 is activated, initially operating at a circulation rate of one complete cycle every 10-20 minutes. Carbon dioxide supplied from the CO₂ feed line pressurizes the material mixing zone to 2-6 MPa and maintains it. The temperature of the heat transfer medium 13 in the jacket 7 is adjusted to control the internal material temperature of the reaction tube between 70° C. and 90° C. During the reaction, materials flow downward through the reaction tube-first passing through the carbon dioxide-epoxide heat transfer unit and then through the solid-liquid mixing unit-before exiting the reaction tube. The circulation device 11 pumps the materials to the liquid distributor 5, which redistributes them across the parallel reaction tubes for recirculation. The reaction is considered complete when the density measured by the density sensor 11 reaches 1.12 g/cm³. As shown in FIG. 1, the upper portion of the reaction tube 9 constitutes the carbon dioxide-epoxide heat transfer unit, and the lower portion constitutes the solid-liquid mixing unit. The gas distributor 6 in the heat transfer unit increases the contact area and residence time between the epoxide and carbon dioxide, allowing the epoxide to absorb CO₂ and release heat, thereby reducing material temperature. As carbon dioxide is consumed, internal pressure drops, triggering CO₂ replenishment through the gas inlet 1. The newly introduced CO₂ also lowers the temperature in the upper region. The circulation device 11 continuously transfers material from the solid-liquid mixing unit to the carbon dioxide-epoxide heat transfer unit. After cooling, the material returns to the solid-liquid mixing unit, ensuring uniform mixing of reactants and products and preventing localized runaway polymerization. As the reaction progresses, material viscosity increases, reducing flow velocity in the solid-liquid mixing unit. Unreacted materials tend to flow downward preferentially, allowing them to reach the gas-liquid mixing zone for further mass and heat transfer. The circulation flow direction is indicated by arrows in FIG. 1. Within the reaction tube, the material temperature increases progressively along the flow direction, forming a gradient: the closer to the bottom, the higher the temperature and the faster the reaction rate. The rate of change in material density is thus used as an indicator for circulation control. When the temperature measured by the second temperature sensor 3-corresponding to the middle region of the reaction tube-exceeds 85° C., the jacket temperature is lowered while increasing circulation speed until the internal temperature stabilizes within 70-90° C. When the temperature difference between the middle and lower regions (i.e., between the second temperature sensor 3 and the third temperature sensor 4) exceeds 5° C., circulation speed is increased until the temperature difference does not exceed 5° C. If the liquid material density changes by more than 0.06 g/cm³ per minute, this indicates an excessively rapid reaction. In response, additional CO₂ is supplied to maintain internal pressure, and the material circulation rate is increased to accelerate mixing and heat dissipation, thereby preventing localized overheating. Through the coordinated operation of the circulation control unit, temperature control unit, and pressure control unit, combined with the cooling function of the carbon dioxide-epoxide heat transfer unit, the temperature in the upper region of the reaction tube (monitored by the first temperature sensor 2) is maintained lower than that in the lower region (monitored by the third temperature sensor 4). The temperature difference between the middle and lower regions (sensed by the second and third temperature sensors, respectively) does not exceed 5° C. Thus, the material temperature along the flow path within the reaction tube increases gradually, forming a stable thermal gradient. The arrangement of the internal reaction tubes 9 within the shell-and-tube reactor is illustrated in FIG. 2, though it is not limited to this specific configuration.

In one embodiment, the carbon dioxide-epoxide heat transfer unit is located within a gas-liquid mass transfer and heat exchange zone. The gas-liquid mass transfer and heat exchange zone occupies the upper space of the reaction tube and has a volume greater than or equal to 20% of the total volume of the reaction tube.

In one embodiment, the gas distributor 6 is positioned 10-50 mm below the top of the reaction tube 9 and has a porous structure. Preferably, the pores are elliptical, with a major axis of 2 mm and a minor axis of 1 mm; more preferably, the porous structure is arranged in a rectangular pattern; and most preferably, the spacing between pores is 3 mm.

In one embodiment, the inner diameter of the reaction tube ranges from 100 mm to 1500 mm. During industrial-scale production of polycarbonate polyether polyols, an excessively small inner diameter directly reduces gas-liquid mass transfer efficiency. When the liquid flows through the carbon dioxide region, the contact area between gas and liquid becomes too small, resulting in poor mass transfer efficiency and failure to achieve the desired polycarbonate polyether polyol composition. This leads to a lower proportion of carbonate segments (as defined in Example 1) and increases the risk of runaway polymerization due to insufficient CO₂ participation. Conversely, an excessively large inner diameter reduces internal heat transfer efficiency. The large diameter causes the solid-liquid mixing unit to be unable to uniformly distribute heat within the materials in a timely manner, resulting in excessive temperature differences between the central and peripheral regions of the tube, which broadens the molecular weight distribution of the product and adversely affects its performance.

In one embodiment, the ratio of the length (L) to the diameter (d) of the reaction tube satisfies 10≤L:d≤40. In the industrial production of polycarbonate polyether polyols, the heating time of the material is critical. Within the shell-and-tube reactor, when the flow rate is constant, a shorter heating time per unit volume results in a significantly reduced reaction conversion rate, necessitating a longer overall reaction time. However, excessive heating duration can lead to the decomposition of polyester segments and discoloration (yellowing) of the product, indicating that the reaction tube should not be excessively long. Meanwhile, since the reaction continuously generates heat, the system temperature tends to rise, requiring the reactor to promptly dissipate the heat produced within the materials. When the flow rate is fixed, the liquid must complete its circulation through the gas-liquid heat transfer zone within a specified time to achieve both heat dissipation and gas-liquid mass transfer. Therefore, the reaction tube must not be overly long. The synthesis of polycarbonate polyether polyols thus requires a reaction tube with a specific length-to-diameter ratio that ensures sufficient heating and reaction time while satisfying the requirements for gas-liquid mass transfer and heat dissipation.

In one embodiment, the number of reaction tubes ranges from two to eight.

In one embodiment, the reaction tubes are connected in parallel, and the center-to-center distance between adjacent tubes is less than or equal to twice the tube diameter.

In one embodiment, the reaction tubes are independent of one another and can be isolated by valves, with identical liquid circulation paths formed between each reaction tube and the circulation control unit.

In one embodiment, the circulation speed of the circulation unit is 10-20 minutes per cycle.

The final reaction product contains polycarbonate polyols, polyether polyols, cyclic carbonates, and unreacted epoxide feedstock. Subsequently, the liquid product is passed through a catalyst filter to recover and recycle the catalyst. The filtrate then flows into a rectification system comprising a falling-film column and a wiped-film evaporator. The filtrate first enters the falling-film column, where the residual epoxide is distilled off and collected in a buffer tank for reuse. The remaining material then flows into the wiped-film evaporator or rectification column, where the main product, polycarbonate polyether polyol, is separated from the by-product, cyclic carbonate. The separation efficiency between the polyol and cyclic carbonate reaches 98%. After complete separation, the two products are collected and stored separately for subsequent use.

The following provides a more detailed description of the shell-and-tube reactor of the present invention through specific embodiments.

### Example 1

8 L of propylene oxide, 4 g of DMC catalyst, and a chain transfer agent at a feed ratio (epoxide-to-chain transfer agent molar ratio) of 55:1 were added to a premixing kettle. Carbon dioxide was introduced at a pressure of 0.4 MPa, and the mixture was stirred at 40° C. for 1 hour. The premixed materials were then pressurized into a reactor array comprising two 8 L reaction tubes, each having an inner diameter of 100 mm and a length of 1000 mm. After all materials were charged, carbon dioxide was introduced into the reaction tubes to reach and maintain a pressure of 3 MPa. The circulation device was started with a flow rate of 600 g/min. Using the second temperature sensor 2 to monitor reaction temperature, the materials were reacted at 80° C. for 3 hours until the density uniformly increased to 1.12 g/cm³ and stabilized, indicating the completion of the reaction. The system was then cooled, and the product was collected. After catalyst removal through a catalyst filtration unit, the crude product was subjected to separation of the main and by-products using a wiped-film evaporator.

The DMC catalyst used in this embodiment is a zinc-cobalt double-metal cyanide complex catalyst prepared by reacting water-soluble salts of zinc and cobalt in an aqueous solvent. Specifically, cobalt thiocyanate sodium and zinc bromide were used at a molar ratio of 1:4. These salts were dissolved in an aqueous solvent composed of water and tert-butanol, with a total metal salt-to-solvent mass ratio of 1:5, and continuously stirred. An inorganic acid (dilute hydrochloric acid, pH=2) and an organic acid (glutaric acid) were added, with a molar ratio of inorganic acid to organic acid of 5:1 and a total metal salt-to-acid molar ratio of 4:1. The mixture was stirred for several hours at 10-100° C., during which a precipitate formed continuously. The resulting suspension was filtered under vacuum, and the filter cake was dried. The dried cake was reslurried and washed with the aqueous solvent at 10-100° C. (specifically at 100° C. for 3 minutes), stirred for several hours, and filtered again. This slurry-wash-dry cycle was repeated multiple times at 60° C. for 6 minutes each cycle until the filtrate pH reached 6-7. The solid product was further vacuum-dried at 80-100° C. to obtain the final catalyst. Prior to use, the catalyst was ground under anhydrous and dry conditions into fine powder particles.

In this embodiment, the chain transfer agent is selected from one or more of ethylene glycol, diethylene glycol, 1,2-propylene glycol, 1,3-propylene glycol, 1,4-butanediol, 1,5-pentanediol, 1,6-hexanediol, 1,4-cyclohexanedimethanol, neopentyl glycol, glycerol, trimethylolpropane, trimethylolethane, 1,2,4-butanetriol, 1,2,6-hexanetriol, pentaerythritol, dipentaerythritol, succinic acid, glutaric acid, adipic acid, pimelic acid, suberic acid, azelaic acid, sebacic acid, dodecanedioic acid, terephthalic acid, isophthalic acid, phthalic acid, mellitic acid, pyromellitic acid, catechol, resorcinol, or hydroquinone.

In this embodiment, the epoxide is selected from at least one of ethylene oxide, propylene oxide, butylene oxide, and epichlorohydrin. Specifically, the epoxide used is propylene oxide (PO).

To meet the quality requirements for downstream polyurethane synthesis applications, the synthesized polycarbonate polyether polyol must satisfy specific quality parameters, primarily evaluated based on molecular weight distribution and carbonate content. The molecular weight distribution is expressed by the polymer polydispersity index (PDI), while the carbonate content is expressed by the proportion of carbonate linkages. A narrower molecular weight distribution (smaller PDI) indicates fewer low-molecular-weight components, minimizing their influence on the polyurethane reaction rate. A higher carbonate content corresponds to a higher proportion of carbonate linkages, improving CO₂ fixation efficiency; however, excessively high carbonate content can adversely affect the balance between soft and hard segments in polyurethane synthesis. The product quality of polycarbonate polyether polyols is classified based on the PDI and carbonate linkage ratio as follows: Products with PDI≤2 and a carbonate linkage ratio of 50-65% are classified as qualified products; Products with PDI≤1.5 and a carbonate linkage ratio of 55-60% are classified as premium-grade products.

The purified product was sampled for analysis. Specifically, the polymerization product (comprising polycarbonate-polyether polyol, cyclic propylene carbonate, and unreacted epoxide) was collected into a container, and the crude product stream was analyzed using proton nuclear magnetic resonance (¹H-NMR) spectroscopy to determine the ratio of polymer to cyclic small molecules. After purification of the polymer, ¹H-NMR analysis was again performed to calculate the ratio of polycarbonate segments to polyether segments (i.e., the carbonate linkage ratio) in the polymer main chain. The calculation method is defined as: Carbonate linkage ratio= (polycarbonate segment)/(polyether segment). Only two types of structural units-polycarbonate and polyether segments-exist in the polymer main chain, and their percentage sum equals 100%.

The content of incorporated carbon dioxide (carbonate segment content) and the ratio of cyclic propylene carbonate to polycarbonate polyether polyol were determined using ¹H-NMR spectroscopy (Bruker DPX400, 400 MHz; pulse program: zg30, delay time d₁=10 s, 64 scans). In each case, the sample was dissolved in deuterated chloroform (CDCl₃). The characteristic chemical shifts (referenced to TMS=0 ppm) were as follows:

The resonance peaks at 5.0 ppm and 4.2 ppm correspond to the protons of the methine and methylene groups in the polycarbonate segments; the peaks at 4.9 ppm, 4.5 ppm, and 4.1 ppm correspond to the protons of the methine and methylene groups in the five-membered cyclic carbonate; and the peaks at 3.5-3.8 ppm correspond to the protons in the ether segments. The integration area of each peak in the ¹H-NMR spectrum is denoted by the capital letter A followed by a subscript indicating the ppm value. For example, A_{5.0} represents the integration area of the peak at 5.0 ppm. Based on the ¹H-NMR spectra and corresponding peak integration areas, the following parameters were calculated for the copolymerization system:

$${F}_{CO 2} = ( {A}_{5.} + {A}_{4.2} - 2 \times {A}_{4.6} ) / [ ( {A}_{5.} + {A}_{4.2} - 2 \times {A}_{4.6} ) + {A}_{3.5} ] \times 100 \% ;$$

$${W}_{PC} = 102 \times {A}_{1.5} / [ 102 \times ( {A}_{5.} + {A}_{4.2} - 2 \times {A}_{4.6} + A 1.5 ) + 58 \times {A}_{3.5} ] \times 100 \% ;$$

$${M}_{CO 2} = 44 \times {F}_{CO 2} / [ 102 \times {F}_{CO 2} + 58 \times ( 1 - {F}_{CO 2} ) ] \times 100 ;$$

In the above formulas, the coefficient 44 represents the molar mass of carbon dioxide (CO₂), the coefficient 58 represents the molar mass of propylene oxide (PO), and the coefficient 102 represents the sum of the molar masses of CO₂ (44 g/mol) and PO (58 g/mol).

The product conversion rate is calculated according to the following formula:

$$n = m \times ( 1 - {M}_{CO 2} ) / ( M - m \times {M}_{CO 2} )$$

where m is the mass of the product after removal of unreacted propylene oxide, and M is the total sample mass including propylene oxide.

The number-average molecular weight (Mn) and polymer polydispersity index (PDI) of the product were determined using gel permeation chromatography (GPC).

The data obtained are shown in Table 1 below:

TABLE 1

| Parameter | Example 1 |
|---|---|
| Epoxide (L) | 8 |
| DMC Catalyst (g) | 4 |
| Chain Transfer Agent Feed Ratio | 55:1 |
| Circulation Flow Rate (g/min) | 600 |
| Actual Conversion (%) | 98 |
| Carbonate Segment Ratio (%) | 59 |
| Mn (g/mol) | 2030 |
| PDI | 1.13 |
| Reaction Completion Time (h) | 3 |

From the data of Example 1, it can be seen that the shell-and-tube reactor of the present invention enables complete reaction of the raw materials at 80° C., producing polycarbonate polyether polyols with a narrower molecular weight distribution (PDI=1.13). The carbonate segment ratio is optimized within the range of 55-60%, indicating a high level of CO₂ fixation while maintaining suitability for downstream applications. Moreover, the reaction time is short, achieving the target conversion within only 3 hours. The shell-and-tube reactor, when operated with one-step feeding, successfully produces high-quality polycarbonate polyether polyols with a conversion rate above 95%, a PDI below 1.5 (indicating a narrow molecular weight distribution), and a carbonate segment ratio between 55% and 60%.

Example 2: Identical to Example 1 except that the amount of propylene oxide charged was 12.8 L, resulting in a gas-to-liquid volume ratio of 1:4.

Example 3: Identical to Example 1 except that Device 2 was used, with a reaction tube inner diameter of 220 mm.

Example 4: Identical to Example 1 except that Device 3 was used, with a reaction tube inner diameter of 1500 mm.

Example 5: Identical to Example 1 except that Device 4 was used, consisting of four reaction tubes, and the amount of propylene oxide charged was 16 L.

Example 6: Identical to Example 1 except that Device 5 was used, consisting of eight reaction tubes, and the amount of propylene oxide charged was 32 L.

Example 7: Identical to Example 1 except that Device 6 was used, with a reaction tube length-to-diameter ratio of 20:1.

Example 8: Identical to Example 1 except that Device 7 was used, with a reaction tube length-to-diameter ratio of 40:1.

Example 9: Identical to Example 1 except that the reaction temperature was maintained at 70° C.

Example 10: Identical to Example 1 except that the reaction temperature was maintained at 90° C.

Example 11: Identical to Example 1 except that the initial circulation cycle time was maintained at 10 minutes per cycle.

Example 12: Identical to Example 1 except that the initial circulation cycle time was maintained at 15 minutes per cycle.

The reaction equipment and operating conditions used in each embodiment are summarized in Tables A and B, where Temperature 1, Temperature 2, and Temperature 3 represent the temperatures of the materials in the upper, middle, and lower sections of the reaction tube, respectively.

TABLE A

| Reactor | Number of | Inner | Length-to-Diameter |
|---|---|---|---|
| Device | Reaction Tubes | Diameter | Ratio (L:d) |
| Device 1 | 2 | 100 mm | 10:1 |
| Device 2 | 2 | 220 mm | 10:1 |
| Device 3 | 2 | 1500 mm | 10:1 |
| Device 4 | 4 | 100 mm | 10:1 |
| Device 5 | 8 | 100 mm | 10:1 |
| Device 6 | 2 | 100 mm | 20:1 |
| Device 7 | 2 | 100 mm | 40:1 |

TABLE B

| | Chain | | | | | | | | |
|---|---|---|---|---|---|---|---|---|---|
| | Transfer | Propylene | | Gas- | | | | Initial | |
| | Agent | Oxide | DMC | Liquid | Temp. 1 | Temp. 2 | Temp. 3 | Circulation | Reactor |
| Example | Ratio | (L) | Catalyst | Ratio | (° C.) | (° C.) | (° C.) | (min/cycle) | Device |
| Ex. 1 | 55:1 | 8 | 500 ppm | 1:1 | 80 | 80 | 83 | 20 | 1 |
| Ex. 2 | 55:1 | 8 | 500 ppm | 1:4 | 80 | 80 | 83 | 20 | 1 |
| Ex. 3 | 55:1 | 16 | 500 ppm | 1:1 | 80 | 80 | 82 | 20 | 2 |
| Ex. 4 | 55:1 | 120 | 500 ppm | 1:1 | 80 | 80 | 83 | 20 | 3 |
| Ex. 5 | 55:1 | 16 | 500 ppm | 1:1 | 80 | 80 | 82 | 20 | 4 |
| Ex. 6 | 55:1 | 32 | 500 ppm | 1:1 | 80 | 80 | 84 | 20 | 5 |
| Ex. 7 | 55:1 | 8 | 500 ppm | 1:1 | 80 | 80 | 84 | 20 | 6 |
| Ex. 8 | 55:1 | 8 | 500 ppm | 1:1 | 80 | 80 | 83 | 20 | 7 |
| Ex. 9 | 55:1 | 8 | 500 ppm | 1:1 | 70 | 70 | 72 | 20 | 1 |
| Ex. 10 | 55:1 | 8 | 500 ppm | 1:1 | 90 | 90 | 94 | 20 | 1 |
| Ex. 11 | 55:1 | 8 | 500 ppm | 1:1 | 80 | 80 | 82 | 10 | 1 |
| Ex. 12 | 55:1 | 8 | 500 ppm | 1:1 | 80 | 80 | 83 | 15 | 1 |

The products obtained from Examples 2-12 were tested following the same procedures as Example 1. The test results are summarized in Table C.

As shown in Table C, in Examples 1 and 3-12, the gas-liquid ratio was 1:1, meaning that

TABLE C

| | Actual | Carbonate | | | |
|---|---|---|---|---|---|
| | Conversion | Segment | | | Reaction |
| Example | (%) | Ratio (%) | Mn(g/mol) | PDI | Time (h) |
| Ex. 1 | 98 | 59 | 2030 | 1.13 | 3 |
| Ex. 2 | 98 | 60 | 2109 | 1.17 | 3 |
| Ex. 3 | 97 | 59 | 2064 | 1.21 | 3 |
| Ex. 4 | 98 | 59 | 2093 | 1.20 | 3 |
| Ex. 5 | 99 | 60 | 2041 | 1.17 | 3 |
| Ex. 6 | 97 | 59 | 2112 | 1.19 | 3 |
| Ex. 7 | 99 | 60 | 2055 | 1.16 | 3 |
| Ex. 8 | 98 | 60 | 2017 | 1.21 | 3 |
| Ex. 9 | 98 | 59 | 2082 | 1.17 | 3 |
| Ex. 10 | 98 | 60 | 2046 | 1.18 | 3 |
| Ex. 11 | 97 | 59 | 2073 | 1.20 | 3 |
| Ex. 12 | 98 | 59 | 2089 | 1.17 | 3 |

the volume of the gas-liquid mass transfer and heat exchange zone accounted for 50% of the total volume of the reaction tube. In Example 2, the CO₂ volume fraction was reduced, thereby decreasing the gas-liquid mass transfer and heat exchange zone to 20% of the reaction tube volume. The molecular weight, molecular weight distribution, and carbonate/ether ratio of the product showed no significant differences, indicating that in the shell-and-tube reactor provided by the present invention, the volume of the gas-liquid mass transfer and heat exchange zone should be not less than 20% of the total reaction tube volume. Compared with Example 1, Examples 3 and 4 used reaction tubes with larger diameters; Examples 5 and 6 increased the number of reaction tubes; and Examples 7 and 8 used reaction tubes with higher length-to-diameter ratios. Examples 3-8 thus represent scaled-up versions of the reactor for industrial application. Based on both the reaction process and product results, the molecular weight, molecular weight distribution, and conversion rate of the polymer exhibited no significant variations. The products had narrow molecular weight distributions and minimal differences in molecular weight indices, yielding products of consistent quality. This demonstrates that the shell-and-tube reactor of the present invention exhibits no scaling effect. Therefore, when scaling up production, it is only necessary to increase the number of parallel reaction tubes and correspondingly adjust the circulation pump flow rate, without requiring any process modification, making it well-suited for industrial-scale production. Furthermore, the parallel reaction tubes of the present invention can share a single heating system, effectively reducing energy consumption during scale-up. From the data of Examples 9 and 10 compared with Example 1, it can be concluded that the reactor of the present invention can synthesize high-quality products at reaction temperatures between 70° C. and 90° C. In Examples 1-10, maintaining the temperature of the material in the upper portion of the reaction tube lower than that in the lower portion, and ensuring that the temperature difference between the middle and lower portions does not exceed 5° C., consistently yielded high-quality polycarbonate polyether polyols. Similarly, from Examples 11 and 12 compared with Example 1, it can be seen that the reactor of the present invention can also produce high-quality products when the circulation cycle time is maintained between 10-20 minutes per cycle.

Comparative Example 1: Identical to Example 1 except that the amount of propylene oxide charged was 13.3 L, resulting in a gas-to-liquid volume ratio of 1:5.

Comparative Example 2: Identical to Example 1 except that the initial circulation cycle time was 5 minutes per cycle.

Comparative Example 3: Identical to Example 1 except that the initial circulation cycle time was 25 minutes per cycle.

Comparative Example 4: Identical to Example 1 except that Device 8 was used, having a reaction tube with an inner diameter of 50 mm.

Comparative Example 5: Identical to Example 1 except that Device 9 was used, having a reaction tube with a length-to-diameter ratio of 50:1.

Comparative Example 6: Identical to Example 1 except that Device 10 was used, comprising ten reaction tubes, with a total propylene oxide charge of 40 L.

Comparative Example 7: Identical to Example 1 except that the temperature difference between Temperature 2 and Temperature 3 exceeded 5° C. during the reaction.

The reaction devices and conditions for the comparative examples are summarized in Tables D and E below.

TABLE D

| Reactor | Numbers of Reaction | Inner | Length-to-Diameter |
|---|---|---|---|
| Device | Tubes | Diameter | Ratio (L:d) |
| Device 8 | 2 | 50 mm | 10:1 |
| Device 9 | 2 | 100 mm | 50:1 |
| Device 10 | 10 | 100 mm | 10:1 |

TABLE E

| | Epoxide-to- | | | | | | | | |
|---|---|---|---|---|---|---|---|---|---|
| | Chain | | | | | | | | |
| | Transfer | Propylene | | Gas- | | | | Initial | |
| | Agent Molar | Oxide | DMC | Liquid | Temp. 1 | Temp. 2 | Temp. 3 | Circulation | Reactor |
| Comp. Ex. | Ratio | (L) | Catalyst | Ratio | (° C.) | (° C.) | (° C.) | (min/cycle) | Device |
| Comp. Ex. 1 | 55:1 | 13.3 | 500 ppm | 1:5 | 84 | 82 | 87 | 20 | 1 |
| Comp. Ex. 2 | 55:1 | 8 | 500 ppm | 1:1 | 80 | 80 | 81 | 5 | 1 |
| Comp. Ex. 3 | 55:1 | 8 | 500 ppm | 1:1 | 82 | 80 | 86 | 25 | 1 |
| Comp. Ex. 4 | 55:1 | 8 | 500 ppm | 1:1 | 81 | 80 | 83 | 20 | 8 |
| Comp. Ex. 5 | 55:1 | 8 | 500 ppm | 1:1 | 85 | 83 | 87 | 20 | 9 |
| Comp. Ex. 6 | 55:1 | 40 | 500 ppm | 1:1 | 81 | 80 | 83 | 20 | 10 |
| Comp. Ex. 7 | 55:1 | 8 | 500 ppm | 1:1 | 99 | 95 | 103 | 20 | 1 |

he products obtained from Comparative Examples 1-7 were tested following the same method as in Example 1. The test results are summarized in Table F below.

TABLE F

| | | Carbonate | | | |
|---|---|---|---|---|---|
| | Actual | Segment | | | Reaction |
| Comp. Ex. | Conversion (%) | Ratio (%) | Mn(g/mol) | PDI | Time (h) |
| Comp. Ex. 1 | 93 | 41 | 2109 | 2.08 | 3 |
| Comp. Ex. 2 | 91 | 56 | 2123 | 1.89 | 4 |
| Comp. Ex. 3 | 96 | 50 | 1892 | 1.93 | 3 |
| Comp. Ex. 4 | 83 | 43 | 2041 | 1.77 | 3 |
| Comp. Ex. 5 | 90 | 35 | 2112 | 2.34 | 2.5 |
| Comp. Ex. 6 | 93 | 58 | 2055 | 1.75 | 3 |
| Comp. Ex. 7 | 95 | 27 | 2017 | 2.31 | 2 |

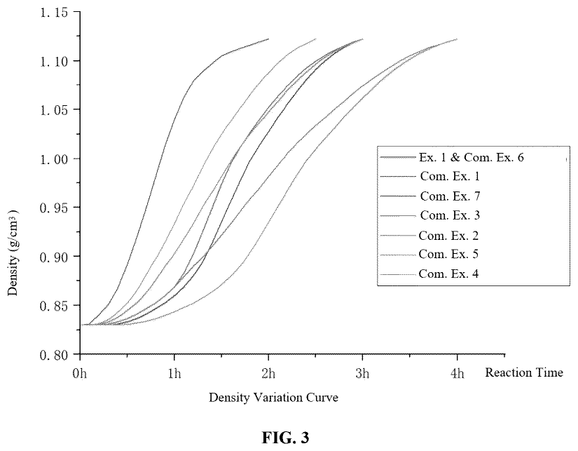

FIG. 3 presents a comparison of the density variation curves for the polycarbonate polyether polyols obtained in Example 1 and Comparative Examples 1-7. In Comparative Example 1, the gas-liquid ratio differed from that of Example 1, reducing the volume of the gas-liquid mass transfer and heat exchange zone. This led to inefficient mass and heat transfer, resulting in a broader molecular weight distribution and lower carbonate content. In Comparative Example 2, the initial circulation rate was faster than in Example 1. As a result, the material temperature within the tube remained relatively low, slowing the reaction rate, extending reaction time, and broadening molecular weight distribution. Conversely, in Comparative Example 3, a slower circulation rate caused the material temperature to remain high, accelerating the reaction rate, reducing CO₂ incorporation, lowering carbonate content, and increasing the risk of runaway polymerization. In Comparative Example 4, the reaction tube diameter was reduced to 50 mm, smaller than the preferred 100 mm, leading to lower carbonate content, broader molecular weight distribution, and reduced conversion. In Comparative Example 5, the tube length-to-diameter ratio was 50:1, which caused poor material mixing and inefficient gas-liquid mass and heat transfer, resulting in low carbonate content and broad molecular weight distribution. In Comparative Example 7, the temperature difference between the middle and lower regions of the reaction tube exceeded 5° C., with the lower region being 8° C. higher. This triggered localized runaway polymerization, causing a sharp temperature rise, and the middle region temperature reached 95° C. As a result, high-quality polycarbonate polyether polyols with PDI below 2 could not be obtained. From the density growth curves, it can be observed that in Comparative Examples 1-7, excessive density growth rates corresponded to large internal temperature fluctuations, yielding poor-quality polyols. Conversely, slower density growth rates prolonged the reaction time and broadened the molecular weight distribution. Comparative Example 6 exhibited a similar density profile to Example 1, as both had the same reaction conditions. However, the use of ten reaction tubes caused greater molecular weight variation among tubes, widening the overall molecular weight distribution. Therefore, the optimal number of reaction tubes in the reactor of the present invention is 2 to 8.

It should be noted that the above embodiments are provided solely to illustrate the technical solutions of the present invention, and not to limit it. Although the invention has been described in detail with reference to preferred embodiments, those skilled in the art will understand that modifications or equivalent substitutions can be made without departing from the spirit and scope of the present invention.

1. A shell-and-tube reactor for synthesizing polycarbonate polyether polyols, comprising a reaction tube, comprising:
a carbon dioxide-epoxide heat transfer unit disposed at an upper portion of the reaction tube for reducing the temperature of the materials;
a solid-liquid mixing unit disposed within the reaction tube and located below the carbon dioxide-epoxide heat transfer unit;
a circulation control unit configured to drive the circulation and flow of materials within the reaction tube;
a temperature control unit configured to regulate the temperature within the reaction tube; and
a pressure control unit configured to regulate the internal pressure of the reaction tube;
wherein the circulation control unit, temperature control unit, and pressure control unit cooperate to control the entire reaction process, wherein:
after one-time feeding of the epoxide, chain transfer agent, and catalyst into the reaction tube, the circulation control unit delivers materials from the solid-liquid mixing unit to the carbon dioxide-epoxide heat transfer unit, and after the material temperature is reduced, returns it to the solid-liquid mixing unit; by adjusting the circulation rate via the circulation control unit and further adjusting the temperature and pressure control units, the temperature of the material in the upper portion of the reaction tube is maintained lower than that in the lower portion, the temperature difference between the middle and lower portions does not exceed 5° C., and the material temperature along the flow direction increases gradually;
wherein the length-to-diameter ratio (L:d) of the reaction tube is less than 50.

2. The reactor according to claim 1, wherein the temperature control unit comprises temperature sensors configured to detect the temperatures of materials in the upper, middle, and lower regions of the reaction tube, a jacket for heating or cooling the reaction tube, and a heat-transfer medium filled between the jacket and the reaction tube.

3. The reactor according to claim 1, wherein, when the temperature in the middle region of the reaction tube exceeds a preset reaction temperature threshold, the temperature control unit reduces the internal temperature of the reaction tube, while the circulation rate and the carbon dioxide feed rate are increased until the middle-region temperature is maintained within the threshold range; and when the temperature difference between the middle and lower regions exceeds a preset temperature-difference threshold, both the circulation rate and carbon dioxide feed rate are increased until the temperature difference is reduced below the threshold.

4. The reactor according to claim 1, wherein, during the reaction process, when the rate of change of material density per minute exceeds a preset density-change threshold, the circulation rate and carbon dioxide feed rate are increased until the density change rate does not exceed the threshold.

5. The reactor according to claim 1, wherein the carbon dioxide-epoxide heat transfer unit is located within a gas-liquid mass transfer and heat exchange zone, which occupies the upper portion of the reaction tube, and wherein the volume of the gas-liquid mass transfer and heat exchange zone is not less than 20% of the total volume of the reaction tube.

6. The reactor according to claim 1, wherein the carbon dioxide-epoxide heat transfer unit comprises a gas distributor located 10-50 mm below the top of the reaction tube, the gas distributor having a porous structure.

7. The reactor according to claim 1, wherein the inner diameter of the reaction tube is 100-1500 mm.

8. The reactor according to claim 1, wherein the length-to-diameter ratio (L:d) of the reaction tube satisfies 10≤L:d≤40.

9. The reactor according to claim 1, wherein the number of reaction tubes is between 2 and 8.

10. The reactor according to claim 9, wherein the reaction tubes are connected in parallel, and the center-to-center distance between adjacent tubes is less than or equal to twice the tube diameter.

11. The reactor according to claim 10, wherein the reaction tubes are mutually independent and can be isolated from one another by valves.

12. The reactor according to claim 11, wherein identical material circulation paths are formed between each reaction tube and the circulation control unit.

13. The reactor according to claim 1, wherein the circulation speed of the circulation control unit is 10-20 minutes per cycle.
